(19) United States
(12) Patent Application Publication
(10) Pub. No.: US 2023/0362198 A1
(43) Pub. Date: Nov. 9, 2023

(54) DYNAMIC SECURITY POLICY ENFORCEMENT METHOD FOR CONTAINER SYSTEM, RECORDING MEDIUM AND SYSTEM FOR PERFORMING THE SAME

(71) Applicant: Foundation of Soongsil University-Industry Cooperation, Seoul (KR)

(72) Inventors: Souhwan JUNG, Seoul (KR); Thien-phuc DOAN, Seoul (KR); Songi GWAK, Seoul (KR)

(73) Assignee: Foundation of Soongsil University-Industry Cooperation, Seoul (KR)

(21) Appl. No.: 18/135,593

(22) Filed: Apr. 17, 2023

(30) Foreign Application Priority Data
May 9, 2022 (KR) 10-2022-0056777

(51) Int. Cl. H04L 9/40

(52) U.S. Cl. CPC H04L 63/20; H04L 63/0263; H04L 63/1416

(57) ABSTRACT

Provided is a dynamic security policy enforcement system for a container system. The dynamic security policy enforcement system comprises a policy management unit for generating and managing a security policy for a container based on a structured format including a set of rules of a predetermined condition; a policy enforcement unit for checking the set of rules when the container requests a system call, changing the security policy of the structured format into a code in a preset format, and transferring the policy changed into the code to a kernel space; and a policy operation decision unit for enforcing the policy received from the policy enforcement unit in the kernel space based on a policy enforcement program that hooks the system call and generating a return value for performing a predetermined operation. Due to this, a policy can be applied to containers in all states including an initialization state and a running state at any time, and there is no need to restart the system or container to apply the policy.

### CROSS-REFERENCE TO RELATED APPLICATIONS

This application claims the benefit of Korean Application No. 10-2022-0056777, filed May 9, 2022, in the Korean Intellectual Property Office. All disclosures of the document named above are incorporated herein by reference.

### TECHNICAL FIELD

The present invention relates to a method for enforcing a dynamic security policy for a container system, a recording medium and a system for performing the same, and more particularly, it relates to a method for enforcing a dynamic security policy for a container system capable of applying a policy without affecting running containers, a recording medium and a system for performing the same.

### BACKGROUND ART

In computing, a system call is a programming method that requests a service from the kernel of an operating system, in which a computer program is executed, and such a system call is a method that helps a program interact with the operating system. When a computer program requests a service from the kernel of the operating system, it calls a system call. The system call is an application program interface (API) and provides services of the operating system to a user program.

In addition, container technology has developed rapidly in recent years and is widely applied to building cloud computing systems such as microservices, edge services, and cloud natives, and the application of security policies to containers is also different from existing cloud systems.

Privacy policies include permitting or disallowing certain operations, and at the lowest level, programs make system calls to the operating system. The security policy is based on analyzing the container’s operation to allow or reject the system call after the container makes the system call.

The prior art of distributing Mandatory Access Control (MAC), such as SELinux, TOMOYO, or AppArmor, which is a kind of security policy enforcement, applies the security policy to the entire system (host OS). In this case, specifying a policy for each container lacks flexibility in that the administrator should rewrite the policy, then compile and restart the system to apply the new policy.

In addition, the prior art of applying restrictions to container tasks and permissions by utilizing Seccomp, Capabilities, and control groups (cgroups) applies security policies in a general way, but there is a problem in that tasks or permission requests are not examined in detail.

For example, security policy enforcement, such as the Docker seccomp security profile, is applied when permitting or denying a list of system calls from execution by the container, without checking the parameter values of the system calls. Accordingly, there is a problem in that important actions of the container service may be denied while unintentionally allowing harmful actions.

That is, in order to use a system call that changes permissions when a system call is called, an argument to determine which file permissions to change is required, and a mode (write, write & read, read) for how to change the permissions is also required. In the case of using seccomp, coarse-grained and detailed control is not possible because it is possible to control only to allow or reject.

In addition, the existing technology, in which the Linux Security Module (LSM), a framework that enables the Linux kernel to support various computer security models without bias, and the Berkeley Packet Filter (BPF), a technology used in programs for network traffic analysis, are combined, applies a sandbox-dedicated security policy. In this case, the security policy is applied to a new process that runs a specific program, but there is a problem in that these concepts are too abstract and difficult for developers to implement in practice. Of course, Aquasecurity’s Tracee supports LSM events using the current eBPF (Linux Kernel’s Extended BPF JIT Virtual Machine) program, but its purpose is to track and audit specific events, and not to actually enforce security policies.

### Prior Art

Korean Patent Application Publication No. 10-2019-0038065

### DISCLOSURE

### Technical Problem

The present invention has been devised to solve the above problems, and an object of the present invention is to provide a dynamic security policy enforcement method for a container system that can apply a policy at any time to containers in all states including an initialization state and a running state, and does not require a system or a container restarting for applying a policy, and a recording medium and system for performing the same.

Meanwhile, another object of the present invention is to provide a dynamic security policy enforcement method for a container system that can dynamically enforce a security policy on any container to permit or deny a list of actions or permissions, and a recording medium and system for performing the same.

Another object of the present invention is a dynamic security policy enforcement method for a container system that can apply a security policy by examining in detail the parameter values of operations and other kernel space contexts accessible only to the kernel, and a recording medium and system for performing the same.

### Technical Solution

In order to achieve the above object, according to an embodiment of the present invention, a dynamic security policy enforcement system for a container system comprises a policy management unit for generating and managing a security policy for a container based on a structured format including a set of rules of a predetermined condition; a policy enforcement unit for checking the set of rules when the container requests a system call, changing the security policy of the structured format into a code in a preset format, and transferring the policy changed into the code to a kernel space; and a policy operation decision unit for enforcing the policy received from the policy enforcement unit in the kernel space based on a policy enforcement program that hooks the system call and generating a return value for performing a predetermined operation.

The security policy may be dynamically applicable to the container in all states including an initialization state or a running state.

The set of rules of a predetermined condition may be one of a system call rule set including a name of a system call and an LSM probe rule set including a name of an LSM function.

The policy enforcement program may be a hooking program using LSM (Linux Security Module) hooking technology.

The policy operation decision unit may comprise a filtering unit for determining whether the received policy violates a security policy and passing a corresponding container based on a result of the determination; a kernel context pre-processing unit for pre-processing a kernel context necessary to determine a validity of a path object included in a specific container if the security policy is not violated; a parsing unit for parsing a condition included in the pre-processed kernel context; and an operation unit for generating a return value for performing a predetermined operation based on an operation according to the parsed condition.

The policy management unit and the policy enforcement unit may be provided in a user space, and the policy operation decision unit is provided in a kernel space.

In order to achieve the above object, according to an embodiment of the present invention, a dynamic security policy enforcement method for a container system performed by a dynamic security policy enforcement system comprises a step of generating and managing a security policy for a container based on a structured format including a set of rules of a predetermined condition; a step of checking the set of rules when the container requests a system call and changing the security policy of the structured format into a code in a preset format based on the checked set of rules; a step of transferring the policy changed into the code to a kernel space; a step of enforcing the policy received from the step of transferring to the kernel space based on a policy enforcement program that hooks the system call; and a step of generating a return value for performing a predetermined operation corresponding to a result of the enforcing.

The security policy may be dynamically applicable to the container in all states including an initialization state or a running state.

The set of rules of the predetermined condition may be one of a system call rule set including a name of a system call and an LSM probe rule set including a name of an LSM function.

The policy enforcement program may be a hooking program using an LSM (Linux Security Module) hooking technology.

The step of enforcing the policy may comprise a step of determining whether the received policy violates a security policy and passing a corresponding container based on a result of the determination; a step of pre-processing a kernel context necessary to determine a validity of a path object included in a specific container if the security policy is not violated; and a step of parsing a condition included in the pre-processed kernel context, wherein the step of generating the return value comprises generating a return value for performing a predetermined operation based on an operation according to the parsed condition.

The step of generating and managing the security policy, the step of changing the security policy into the code in the preset format and the step of transferring the policy changed into the code to the kernel space may be performed in a user space, while the step of enforcing the received policy and the step of generating the return value are performed in a kernel space.

In order to achieve the above object, according to another embodiment of the present invention, a computer program for executing a dynamic security policy enforcement method for a container system is recorded on a computer-readable storage medium.

### Advantageous Effects

According to one aspect of the present invention described above, by providing a dynamic security policy enforcement method for a container system, a recording medium, and a system for performing the same, a policy can be applied to containers in all states including an initialization state and an execution state at any time, and there is no need to restart the system or container for the policy to be applied.

And security policies can be dynamically enforced on any container to allow or deny a list of actions or permissions, and a security policy can be applied by examining in detail parameter values of operations and other kernel space contexts accessible only to the kernel.

### DESCRIPTION OF DRAWINGS

These and/or other aspects will become apparent and more readily appreciated from the following description of the embodiments, taken in conjunction with the accompanying drawings in which:

FIGS. 1 and 2 are diagrams for describing the configuration of a dynamic security policy enforcement system according to an embodiment of the present invention;

FIG. 3 is a diagram for describing a security policy configured in a dynamic security policy enforcement system according to an embodiment of the present invention;

FIG. 4 is a diagram for describing a policy operation decision unit according to an embodiment of the present invention, and

FIG. 5 is a flowchart illustrating a dynamic security policy enforcement method according to an embodiment of the present invention.

### DETAILED DESCRIPTION OF EMBODIMENTS

The detailed description of the present invention which follows refers to the accompanying drawings which illustrate, by way of illustration, specific embodiments in which the present invention may be practiced. These embodiments are described in sufficient detail to enable those skilled in the art to practice the present invention. It should be understood that the various embodiments of the present invention are different from each other but are not necessarily mutually exclusive. For example, specific shapes, structures, and characteristics described herein may be implemented in another embodiment without departing from the spirit and scope of the invention in connection with one embodiment. Additionally, it should be understood that the location or arrangement of individual components within each disclosed embodiment may be changed without departing from the spirit and scope of the invention. Accordingly, the detailed description set forth below is not to be taken in a limiting sense, and the scope of the present invention, if properly described, is limited only by the appended claims, along with all equivalents as claimed by those claims. Like reference numbers in the drawings indicate the same or similar function throughout the various aspects.

Components according to the present invention are components defined not by physical division but by functional division, and may be defined by the functions each performs. Each of the components may be implemented as hardware or program codes and processing units that perform respective functions, and the functions of two or more components may be implemented by being included in one component. Therefore, the names given to the components in the following embodiments are not to physically distinguish each component, but to imply the representative function performed by each component, and it should be noted that the technical idea of the present invention is not limited by the names of the components.

Hereinafter, preferred embodiments of the present invention will be described in more detail with reference to the drawings.

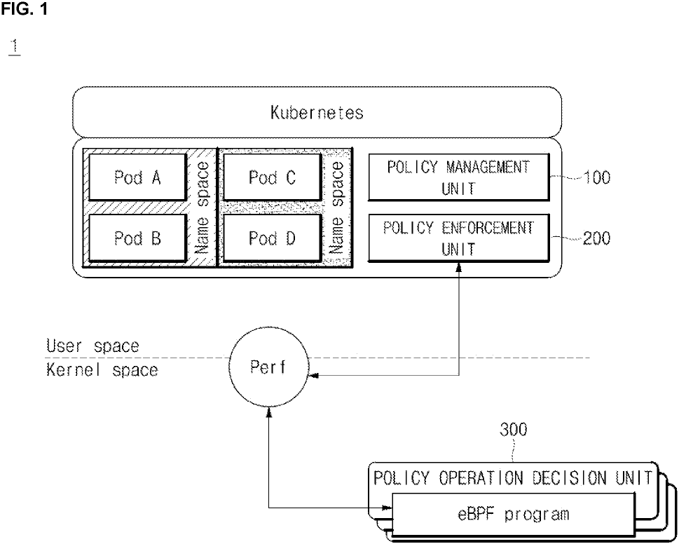

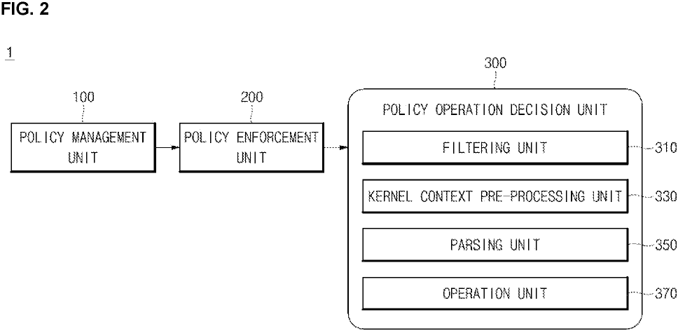

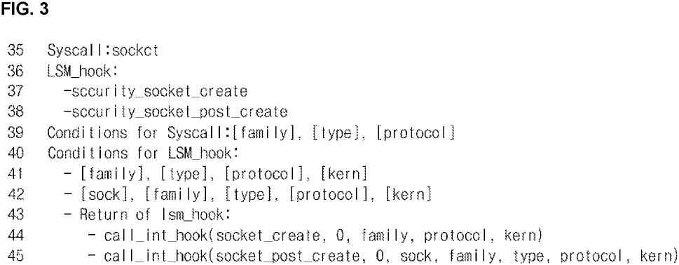

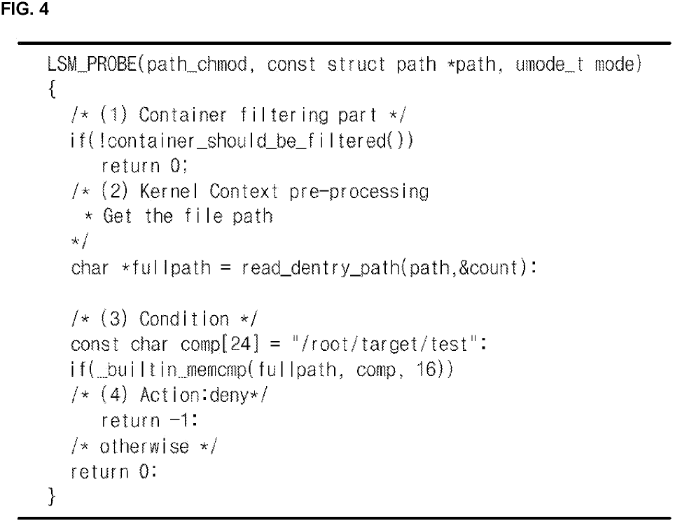

FIGS. 1 and 2 are diagrams for describing a dynamic security policy enforcement system 1 according to an embodiment of the present invention, and FIG. 3 is a diagram describing a security policy configured in the dynamic security policy enforcement system 1 according to an embodiment of the present invention, and FIG. 4 is a diagram for describing a policy operation decision unit 300 according to an embodiment of the present invention.

The dynamic security policy enforcement system 1 (hereinafter, as referred to the system) according to the present invention enables the policy to be applied at any time without affecting the running container and does not require restarting the container after applying the policy, and also may examine kernel parameters in detail for any event.

Referring to FIG. 1, the system 1 according to the present invention may include a policy management unit 100, a policy enforcement unit 200 and a policy operation decision unit 300.

In the system 1 of the present invention, software (application) for performing a dynamic security policy enforcement method for a container system can be installed and executed, and the configuration of the policy management unit 100, the policy enforcement unit 200, and the policy operation decision unit 300 may be controlled by software for performing a dynamic security policy enforcement method for a container system running in the system.

And, the system 1 may be a separate terminal or a part of a module of the terminal. In addition, the configuration of the policy management unit 100, the policy enforcement unit 200, and the policy operation decision unit 300 may be formed as an integrated module or may be composed of one or more modules. However, on the contrary, each component may be composed of a separate module.

The system 1 can also be mobile or stationary. Such a system may be in the form of a server or an engine and can be called other terms including a device, an apparatus, a terminal, a user equipment (UE), a mobile station (MS), and a wireless device, handheld device, etc.

In addition, the system 1 may execute or manufacture various software based on an operating system (OS). The operating system is a system program for enabling software to use the hardware of the device and can include a mobile computer operating system such as Android OS, iOS, Windows mobile OS, Bada OS, Symbian OS, Blackberry OS, and a computer operating system such as Windows-based, Linux-based, Unix-based, MAC, AIX, and HP-UX.

In general, a system call is an interface through which a user layer of a computer can request a service from a kernel, and a system call can allow a program to interact with an operating system. When actually coding, in order to use a specific function in the kernel of the operating system, a system call is called to implement the corresponding function.

Therefore, rules are basically determined in the security policy system, and the corresponding rules are applied to the computer system. The system 1 in the present invention intends to implement the security policy system based on the system call.

To this end, the policy management unit 100 may generate and manage a security policy for a container based on a structured format including a set of rules of predetermined conditions.

The policy management unit 100 may manage the security policy for all Kubernetes systems in a structured format such as yaml (Yet Another Markup Language, one of the markup languages), which is one of the data serialization forms, that is, a specific format file, and security policies can be applied to each container or pod or each container namespace.

Specifically, the policy management unit 100 includes all containers existing in one pod, containers existing in the same pod, and containers existing in the same namespace (meaning both Linux namespace and Kubernetes namespace). In other words, it can provide functions for managing security policies for each management unit at different levels.

Through the policy management unit 100, an administrator may configure a security policy through a structured file format including a set of rules of predetermined conditions, that is, a file format such as yaml or json (JavaScript Object Notation).

Here, the rule set of predetermined conditions may be one of a system call rule set including a system call name and an LSM probe rule set including an LSM function name. These rule sets can be selected by the administrator.

More specifically, the system call rule set may include <Syscall> <Condition> <Action>. In this system call approach, the policy management unit 100 needs to understand the system call and the map along with the corresponding LSM probe to be a hook. However, since the mapping is defined in advance, some functions or parameters may be omitted. However, since LSM probes can be difficult even for administrators who are users, a system call approach that includes these system call rule sets is provided.

Specifically, a probe with a header of ‘security’ is included in the system call, which is called an LSM probe, and can be used for checking errors.

Meanwhile, a hook is hung on an error, and when the hook is hooked, LSM implementation can be performed. In this case, the LSM implementation may mean the task of determining what kind of operation the policy enforcement program will perform in a secure manner. Therefore, even if the administrator wants to manage the security policy more precisely, the LSM probe can be used as a probe approach.

The LSM probe rule set may include <LSM probe> <Condition> <Action>. In this LSM probe approach, the policy management unit 100 may parse rules and transfer them to the policy enforcement unit 200 to build a policy enforcement program. This LSM probe approach gives administrators the most flexibility in writing rules.

The system call (Syscall) included in the above-mentioned system rule set means the name of the system call, and the LSM probe included in the LSM probe rule set may mean the name of an LSM function that can be found in include/linux/security.h (Linux source).

In addition, Condition included in the two types of rule sets means a condition between a parameter and a value in the form of an LSM function. If there is a system call, it may mean an argument that should be entered in it, that is, a parameter, and Action may mean specifying an action for permission or denial.

More specifically, the following LSM function will be described as an example.

static inline int security_path_chmod(const struct path *path, umode_t mode)
{
return 0;
}

For the above LSM function, Condition can be path -> dentry.d_iname == “test,” and this Condition compares whether the file name and string are “test” or not, and if the file name is “test,” Condition returns TRUE, otherwise it returns FALSE. At this time, Condition should be in a C coded form.

And Action can include Allow, Deny, and Taint, and Taint can mean that an event is recorded when Condition is TRUE.

As described above, the system 1 according to the present embodiment is provided in a way that the rule set can be selected from two types so that the administrator can write a security policy in detail.

Specifically, a probe exists inside a system call, and each probe existing inside a system call includes a hooking point. Accordingly, there may be cases, in which the arguments corresponding to the conditions are different even under conditions for performing the same operation. For example, a system call includes three arguments, and for a probe, only one or two of them are used. Likes the above, since the used arguments, here the conditions, are different, two approaches are provided and let the administrator choose one of them.

When the code screen shown in FIG. 3 is described as an example, although there is one system call (35), there may be two LSM hooks (37, 38) using the system call. Also, while the system call condition can provide a total of three arguments [family], [type], and [protocol], the arguments used in the actual LSM hook may be 4 such as [family], [type], [protocol], [kern] or 5 such as [sock], [family], [type], [protocol], [kern]. Therefore, in this system, two approaches may be provided to support all of these cases.

Meanwhile, the policy enforcement unit 200 checks a rule set when a container requests a system call, changes the security policy in a structured format into a code in a preset format based on the checked rule set, and transfers the policy changed into the code to the kernel layer (kernel space).

The policy enforcement unit 200 may distribute and control a policy enforcement program, and may communicate with policy enforcement programs in a kernel layer (kernel space) through Perf. At this time, the policy enforcement program to be distributed and controlled may be a Berkeley Packet Filter (eBPF).

BPF is a technology used in a specific computer operating system, especially a technology used in a program for network traffic analysis, and eBPF means an extended BPF JIT virtual machine in the Linux kernel. It can provide a raw interface to the data link layer so that raw link layer packets can be transmitted and received. Since BPF supports packet filtering, it is possible to provide a filter program that specifies the packets that user space processes want to receive. For example, the tcpdump process may only want to receive packets initiating TCP connections. BPF only returns packets that pass through the filter provided by the process, which has the advantage of significantly improving performance by not copying unwanted packets from the operating system kernel to the process.

On the other hand, eBPF is a technology derived from the Linux kernel that can run sandboxed programs in the operating system kernel. It can be used to safely and efficiently extend the functionality of the kernel without the need to change the kernel source code or load kernel modules. Accordingly, in the present invention, the eBPF program can be used as a policy enforcement program.

Policy enforcement in the policy enforcement unit 200 may be a set of Python scripts that build, compile the eBPF program, and load it into the LSM hook using the bpf system call.

Through this, the policy enforcement unit 200 can check the rule set for the policy in the yaml format managed by the policy management unit 100 through Python and then convert it into C language code.

Accordingly, the policy enforcement unit 200 may write eBPF code in C language code and compile the eBPF code using an open source project such as bcc or libbpf.

In addition, the policy enforcement in the policy enforcement unit 200 can load the eBPF program into the corresponding LSM function without requiring a container. This is because the eBPF program, a policy enforcement program, can be executed in the kernel Virtual Machine (VM) through the bpf system call.

Since the LSM framework is designed for modular function loading, eBPF programs, which are security policy enforcement programs, can be safely and dynamically loaded.

Further, the policy enforcement performed by the policy enforcement unit 200 may build a filtering function for the eBPF program so that the policy management unit 100 can apply the security policy to the correct object.

In addition, the policy enforcement unit 200 can load a policy enforcement program into an LSM function and control it in units of containers, pods, or Kubernetes namespaces.

Specifically, each container is isolated by the namespace mechanism, so any process in a container cannot be forced or cloned into a different namespace. Therefore, it follows the rules of inheritance, i.e., the same namespace and the same set of cgroups. The namespace here can mean a Linux namespace different from the Kubernetes namespace. Containers can be filtered according to security policies by extracting the namespace ID from the container’s root process and using bpf_get_current_task() (eBPF helper) to compare it with the current event information (kernel space context) of the process that generates the event (e.g. system call request).

Meanwhile, for each pod, containers from the same pod can be in the same Linux namespace or different namespaces. In this case, if the namespace IDs are different, policy enforcement simply adds one more filtering rule to the eBPF code that declares a list of namespace IDs of target pods to be filtered.

In addition, the policy enforcement unit 200 may use kubectl to fetch information about all containers in the namespace for each Kubernetes namespace for policy enforcement, and then perform the same technique as pod filtering.

The policy management unit 100 and the policy enforcement unit 200 may be provided in a user layer (user space) as shown in FIG. 1.

In addition, the policy enforcement unit 200 may communicate with the policy operation decision unit 300 provided in the kernel layer through Perf as shown. Perf, which is used to be a performance counter PCL for Linux, is also called perf_events or Perf tool, and is a Linux performance analysis tool available from the 2009 Linux kernel version 2.6.31. This Perf can perform statistical profiling of the entire system, and can collect and visualize various system indicators at a general level.

In the present invention, by using the eBPF program as a policy enforcement program, tracing and instrumenting may be possible in a kernel layer function. Since 2015, the Linux kernel has supported for the first time eBPF programs to output data as perf events, which can make it easier for the user space to collect information from the kernel layer with a tracing program.

Therefore, in the present invention, a security policy system can be finally implemented in a form, in which a policy enforcement program can output data as an event using such Perf.

Therefore, the policy management unit 100 and the policy enforcement unit 200, which are provided in the form of pods in the Kubernetes system, decide which pod to control, and the policy enforcement program actually enforces the security policy. In addition, Perf for communication between the policy enforcement unit 200 and the policy operation decision unit 300 extracts and views events.

Also, the security policy in the present invention may be a stackable security policy. Conventionally, if the call system was controlled through one policy file for all hosts or all systems, in the present invention, multiple security policies can be used and multiple security policies can be stacked.

Specifically, if multiple policies that affect the same LSM probe and kernel context are included, a return value can be generated and returned in such a way that one of the LSM hook results that are finally output is selected. At this time, if a return value generated as -1 exists during the determined operation, the final return value may be determined as -1. As in the above-mentioned rule set, there can be multiple LSM hooks for one system call, and even if it is not a single system call, since there may be a case to access any specific socket or the same kernel context, this system can provide a stackable security policy.

Meanwhile, the policy operation decision unit 300 may enforce the policy received from the policy enforcement unit 200 in a kernel layer (kernel space) based on a policy enforcement program that hooks system calls, and generate a return value for performing predetermined operations.

Here, the policy enforcement program may be the aforementioned eBPF program and may be a hooking program using Linux Security Module (LSM) hooking technology.

The eBPF program written in C language through the policy enforcement unit 200 is loaded into the LSM function to enforce the security policy, and as described above, the eBPF program, which is the policy enforcement program, follows the LSM framework rules. That is, it follows the rules of the LSM framework that checks the condition and decides whether or not to actually pass it. When a more specifically defined hook point is hooked, the policy enforcement program performs a specific operation, and as a result, it returns 0 or -1 as a return value depending on whether the operation is an error or not. At this time, 0 may be returned as a return value meaning pass (allowed) or a return value meaning not passed (denied) (which can be an integer other than 0 as an error code) may be returned.

To this end, the policy operation decision unit 300 may be provided in a kernel layer (kernel space) and may include a filtering unit 310, a kernel context pre-processing unit 330, a parsing unit 350, and an operation unit 370.

The filtering unit 310 may determine whether the received policy violates the security policy, and pass the corresponding container based on the determination result.

The kernel context pre-processing unit 330 may pre-process a kernel context necessary to determine the validity of a path object included in a specific container if the received policy does not violate the security policy, that is, if it passes the filtering unit 310.

The parsing unit 350 may parse conditions included in the pre-processed context.

The operation unit 370 may generate a return value for performing a predetermined operation based on the operation according to the parsed condition.

The overall process in the policy operation decision unit 300 including the filtering unit 310, the kernel context pre-processing unit 330, the parsing unit 350, and the operation unit 370 is shown in FIG. 4 as an example. Hereinafter, the filtering unit 310, the kernel context pre-processing unit 330, the parsing unit 350, and the operation unit 370 will be described based on the code shown in FIG. 4.

In FIG. 4, Container filtering part may be a process performed by the filtering unit 310. The filtering unit 310 may be a component in the first part of the security policy program in order to reduce unnecessary computing resources.

As shown in FIG. 4, a container outside the scope of the current security rule immediately denies the operation of the policy enforcement program, that is, the eBPF program, and cannot proceed to (2) Kernel Context pre-processing part performed by the kernel context pre-processing unit 330.

Specifically, in the filtering unit 310, if the security rule is not a part that can be handled, the container is immediately passed. For example, in FIG. 4, ‘!’ means that the security rule is not met, and if it becomes ‘!,’ 0 is returned, so the policy enforcement program can be terminated as a denial operation.

Meanwhile, (2) Kernel Context pre-processing part is a process performed by the kernel context pre-processing unit 330, and the policy enforcement program can access the kernel context of the current kernel event by using the function of the LSM hook.

For example, an LSM function named security_path_chmod may be called by the LSM framework during a chmod system call is requested in a user space process. This function can be a function that gets a path object containing information about the target file and determines whether the change mode task is valid or not. This is an example of a kernel context since information about the target file is only observed by the kernel. Therefore, the context required for the LSM hook should be pre-processed. The eBPF program, which is a policy enforcement program according to the present invention, can save computing resources by limiting it to 10000 instructions, and can make implemented policies as simple as possible.

More specifically, referring to FIG. 4 as an example, the kernel context pre-processing unit 330 receives a path, as shown, when receiving an argument. For example, the path to the file or directory desired to be handled, such as directory, etc or a specific text file in directory, etc., is received.

However, since the path itself cannot control system calls or LSM hooks, it needs to be changed to a kernel context that can be understood by the kernel layer. Accordingly, as shown in FIG. 4, the kernel context pre-processing unit 330 may obtain the dentry_path by inserting *path, which is a path to a file desired to be handled or a path to a directory desired to be handled, into the path. The full path obtained here can be information about the path that the kernel layer can understand. That is, the kernel context pre-processing unit 330 may convert path information received from the user layer into a context in the kernel.

The condition part is a process performed by the parsing unit 350 and can parse policies by policy enforcement components. That is, the parsing unit 350 may parse the condition.

Meanwhile, (4) Action: deny is a process performed by the operation unit 370, and the return value of the LSM hook implemented by the policy enforcement program can become a policy operation. The return value generated when the operation is allowed may be 0, otherwise the return value may be -1. Meanwhile, if the operation is denied, the return value may be -1, otherwise the return value may be 0. Also, if the operation is a taint, the code snippet sends logging values to the Perf ring, which is a communication ring buffer that allows values to be read in the user layer from the kernel layer, and the return value may always be zero.

The system according to an embodiment of the present invention including the policy management unit 100, the policy enforcement unit 200, and the policy operation decision unit 300 may dynamically apply security policies to containers in all states including an initialization state or a running state. Another advantage is that the system or container does not need to be restarted to apply the security policy.

A security policy can be dynamically enforced on any container to allow or deny a list of actions or permissions, and a security policy can be applied by examining in detail parameter values of operations and other kernel-space contexts accessible only to the kernel. Further, Kernel context parameters are also visible to the user layer.

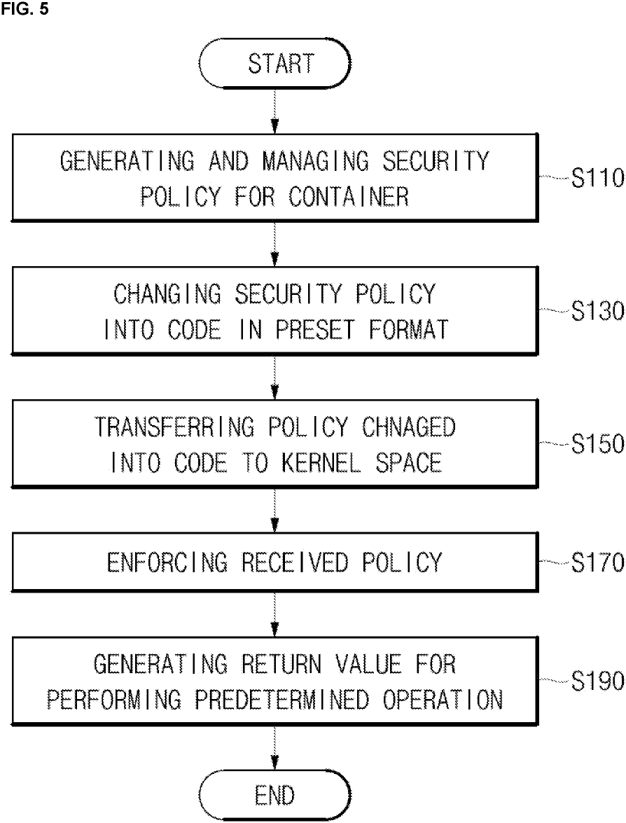

Meanwhile, FIG. 5 is a flowchart illustrating a dynamic security policy enforcement method according to an embodiment of the present invention. Since the dynamic security policy enforcement method according to an embodiment of the present invention proceeds on substantially the same configuration as the dynamic security policy enforcement system 1 shown in FIG. 1, the same reference numerals are assigned to the same components, and repeated descriptions will be omitted.

A dynamic security policy enforcement method for a container system according to an embodiment of the present invention includes the steps of generating and managing a security policy for a container (S110), the step of changing the security policy into a code in a preset format (S130), the step of transferring the policy changed into the code to a kernel layer (kernel space) (S150), the step of enforcing the transferred policy (S170), and the step of generating a return value to perform a predetermined operation (S190).

In the step of generating and managing the security policy for the container (S110), the policy management unit 100 may generate and manage the security policy for the container based on a structured format including a set of rules of a predetermined condition.

Here, the rule set of a predetermined condition may be at least one of a system call rule set including a system call name and an LSM probe rule set including an LSM function name, and such a rule set may be selected by an administrator.

In the step of changing the security policy into a code of a predetermined format (S130), the policy enforcement unit 200 may check a rule set included in the structured format when the container requests a system call. Further, the policy enforcement unit 200 may change the security policy of the structured format into a code of a preset format based on the checked rule set.

Thereafter, the policy enforcement unit 200 may perform the step (S150) of transferring the policy changed into the code to a kernel layer (kernel space).

Meanwhile, in the step of enforcing the transferred policy (S170), the policy operation decision unit 300 may enforce the policy received from the step of transferring the policy to the kernel layer (kernel space) (S150) based on the policy enforcement program hooking the system call.

In this case, the policy enforcement program is a hooking program using Linux Security Module (LSM) hooking technology and may be an eBPF program.

In the step S170 of the policy operation decision unit 300 enforcing the policy, it may comprise a step of determining whether the received policy violates the security policy and passing the corresponding container based on the result of the determination, a step of pre-processing a kernel context necessary to determine the validity of a path object included in a specific container if the security policy is not violated, and a step of parsing a condition included in the pre-processed context.

In the step of generating a return value to perform a predetermined operation (S190), a return value may be generated to perform a predetermined operation corresponding to the result of enforcing the policy in the step of enforcing the received policy (S170). In the step of generating the return value (S190), a return value for performing a predetermined operation may be generated based on the operation according to the parsed condition.

Through this, the security policy is dynamically applicable to containers in all states including the initialization state or running state.

And, the step of generating and managing security a policy (S110), the step of changing the security policy into a code in a preset format (S130), and the step of transferring the policy to the kernel layer (S150) may be performed in the user space, the step of enforcing the received policy (S170) and the step of generating a return value (S190) may be performed in a kernel space.

The dynamic security policy enforcement method for the container system of the present invention may be implemented in the form of program instructions that can be executed through various computer components and recorded on a computer-readable recording medium. The computer-readable recording medium may include program instructions, data files, data structures alone or in combination.

The program instructions recorded on the computer-readable recording medium may be specially designed and configured for the present invention, or may be known and usable to those skilled in the art of computer software.

Examples of computer-readable recording media include magnetic media such as hard disks, floppy disks and magnetic tapes, optical recording media such as CD-ROMs and DVDs, and magneto-optical media such as floptical disks, and hardware devices specially configured to store and execute program instructions, such as ROM, RAM, flash memory, and the like.

Examples of program instructions include high-level language codes that can be executed by a computer using an interpreter as well as machine language codes produced by a compiler. The hardware device may be configured to act as one or more software modules to perform processing according to the present invention and vice versa.

Although various embodiments of the present invention have been shown and described above, the present invention is not limited to the specific embodiments described above. Various modifications and implementations are possible by those skilled in the art to which the invention pertains without departing from the gist of the invention claimed in the claims, and these modified implementations should not be individually understood from the technical spirit or perspective of the present invention.

### REFERENCE NUMERAL

100: policy management unit
200: policy enforcement unit
300: policy operation decision unit
310: filtering unit
330: kernel context pre-processing unit
350: parsing unit
370: operation unit

1. A dynamic security policy enforcement system for a container system comprising:
a policy management unit for generating and managing a security policy for a container based on a structured format including a set of rules of a predetermined condition;
a policy enforcement unit for checking the set of rules when the container requests a system call, changing the security policy of the structured format into a code in a preset format, and transferring the policy changed into the code to a kernel space; and
a policy operation decision unit for enforcing the policy received from the policy enforcement unit in the kernel space based on a policy enforcement program that hooks the system call and generating a return value for performing a predetermined operation.

2. The dynamic security policy enforcement system of claim 1, wherein the security policy is dynamically applicable to the container in all states including an initialization state or a running state.

3. The dynamic security policy enforcement system of claim 1, wherein the set of rules of a predetermined condition is one of a system call rule set including a name of a system call and an LSM probe rule set including a name of an LSM function.

4. The dynamic security policy enforcement system of claim 1, wherein the policy enforcement program is a hooking program using an LSM (Linux Security Module) hooking technology.

5. The dynamic security policy enforcement system of claim 1, wherein the policy operation decision unit comprises,
a filtering unit for determining whether the received policy violates a security policy and passing a corresponding container based on a result of the determination;
a kernel context pre-processing unit for pre-processing a kernel context necessary to determine a validity of a path object included in a specific container if the security policy is not violated;
a parsing unit for parsing a condition included in the pre-processed kernel context; and
an operation unit for generating a return value for performing a predetermined operation based on an operation according to the parsed condition.

6. The dynamic security policy enforcement system of claim 1, wherein the policy management unit and the policy enforcement unit are provided in a user space, and the policy operation decision unit is provided in a kernel space.

7. A dynamic security policy enforcement method for a container system performed by a dynamic security policy enforcement system comprising:
a step of generating and managing a security policy for a container based on a structured format including a set of rules of a predetermined condition;
a step of checking the set of rules when the container requests a system call and changing the security policy of the structured format into a code in a preset format based on the checked set of rules;
a step of transferring the policy changed into the code to a kernel space;
a step of enforcing the policy received from the step of transferring to the kernel space based on a policy enforcement program that hooks the system call; and
a step of generating a return value for performing a predetermined operation corresponding to a result of the enforcing.

8. The dynamic security policy enforcement method of claim 7, wherein the security policy is dynamically applicable to the container in all states including an initialization state or a running state.

9. The dynamic security policy enforcement system of claim 7, wherein the set of rules of the predetermined condition is one of a system call rule set including a name of a system call and an LSM probe rule set including a name of an LSM function.

10. The dynamic security policy enforcement method of claim 7, wherein the policy enforcement program is a hooking program using an LSM (Linux Security Module) hooking technology.

11. The dynamic security policy enforcement method of claim 7, wherein the step of enforcing the policy comprises,
a step of determining whether the received policy violates a security policy and passing a corresponding container based on a result of the determination;
a step of pre-processing a kernel context necessary to determine a validity of a path object included in a specific container if the security policy is not violated; and
a step of parsing a condition included in the pre-processed kernel context,
wherein the step of generating the return value comprises generating a return value for performing a predetermined operation based on an operation according to the parsed condition.

12. The dynamic security policy enforcement method of claim 7, wherein the step of generating and managing the security policy, the step of changing the security policy into the code in the preset format and the step of transferring the policy changed into the code to the kernel space are performed in a user space, and the step of enforcing the received policy and the step of generating the return value are performed in a kernel space.

13. A computer-readable storage medium, on which a computer program for executing the dynamic security policy enforcement method of claim 7 is recorded.
